(19) United States
(12) Patent Application Publication
(10) Pub. No.: US 2011/0090428 A1
(43) Pub. Date: Apr. 21, 2011

(54) LIQUID CRYSTAL DISPLAY DEVICE

(76) Inventors: Noritaka Ajari, Osaka (JP); Yasuyoshi Kaise, Osaka (JP)

(21) Appl. No.: 12/999,562

(22) PCT Filed: Jun. 11, 2009
(86) PCT No.: PCT/JP2009/002636

§ 371 Date: Dec. 16, 2010

(30) Foreign Application Priority Data
Jun. 17, 2008 (JP) 2008-157509

(51) Int. Cl. G02F 1/1335

(52) U.S. Cl. 349/67

(57) ABSTRACT

A liquid crystal display device 100 according to the present invention includes: a liquid crystal layer 32 interposed between first and second substrates 11, 21; a pixel electrode 10, which includes a reflective pixel electrode 10r and a transparent pixel electrode 10t; a counter electrode 22; an organic insulating layer 24a, which has been deposited on the counter electrode 22 to face the liquid crystal layer 32; and a columnar spacer 24b arranged between the first and second substrates 11 and 21. The organic insulating layer 24a covers only the reflecting region R selectively or the counter electrode 22 substantially entirely, and is thicker in the reflecting region R than in the transmitting region T. And the columnar spacer 24b is made of the same organic film as the organic insulating layer 24a.

### TECHNICAL FIELD

The present invention relates to a liquid crystal display device and more particularly relates to a transmissive-reflective liquid crystal display device.

### BACKGROUND ART

A liquid crystal display (LCD) in which each of its pixels has a reflecting region to conduct a display operation in reflection mode and a transmitting region to conduct a display operation in transmission mode, is called either a “transmissive-reflective LCD” or a “transflective LCD”. A transflective LCD has a backlight and can conduct a display operation in transmission mode using the light emitted from the backlight and a display operation in reflection mode using ambient light either at the same time or with the modes of operation switched from one of those two into the other. And such transflective LCDs are currently used extensively in mid- to large-sized mobile display devices to be used outdoors such as the LCD monitor of cellphones, among other things.

Some conventional transflective LCDs adopt a structure in which the liquid crystal layer has a smaller thickness in the reflecting region than in the transmitting region to improve the display quality in its transmission and reflection modes. And such a structure is sometimes called a “multi-gap structure”. It is most preferred that a part of the liquid crystal layer in the reflecting region is a half as thick as another part of it in the transmitting region. The incoming light that contributes to getting a display operation done in the reflection mode passes the same liquid crystal layer twice. That is why if a part of the liquid crystal layer in the reflecting region is a half as thick as another part of it in the transmitting region, then substantially the same degree of retardation will be caused by the liquid crystal layer, no matter whether the incident light is going to be used to conduct a display operation in the reflection mode or in the transmission mode. As a result, the best voltage-luminance characteristic will be achieved in both of the reflecting and transmitting regions.

In a transflective LCD with such a multi-gap structure, there is a level difference in each pixel to reduce the thickness of the liquid crystal layer in the reflecting region. For example, in the arrangement disclosed in Patent Document No. 1, by providing an interlayer insulating film under the reflective electrode on its TFT substrate, the thickness of the liquid crystal layer can be smaller in the reflecting region by the thickness of that interlayer insulating film than in the transmitting region. Meanwhile, also known is an opposite type of arrangement, in which the thickness of the liquid crystal layer is reduced in the reflecting region by providing a transparent resin layer for the reflecting region of its color filter substrate, which is arranged opposite to its TFT substrate so as to face the viewer (see Patent Document No. 2, for example).

If such a level difference is made in each pixel by using either an interlayer insulating film or a transparent resin layer, however, there will be a slope on the boundary between the reflecting and transmitting regions. And the thickness of the liquid crystal layer on that slope will be far from the best one in both of the reflection and transmission modes. That is why that slope never contributes effectively to getting a display operation done. On top of that, the alignment directions of liquid crystal molecules to be defined by the alignment layer on the slope are different from those of liquid crystal molecules to be defined by the alignment layer on the flat surface of the substrate, thus debasing the display quality. Furthermore, if an electrode is arranged on the slope, then the electric field generated near that slope will be oblique with respect to the surface of the liquid crystal layer (which is parallel to the surface of the substrates). That is to say, the direction of such an oblique electric field is different from that of an electric field generated in any other region perpendicularly to the surface of the liquid crystal layer. Consequently, the alignment directions of liquid crystal molecules near the slope are different from those of liquid crystal molecules in any other region, thus possibly deteriorating the display quality.

Meanwhile, Patent Document No. 3 discloses an LCD for realizing the best voltage-luminance characteristic in both of the reflecting and transmitting regions by driving the reflecting and transmitting regions independently of each other without adopting the multi-gap structure described above.

The LCD disclosed in Patent Document No. 3, however, has so complicated a structure that there is a concern about a rise in manufacturing cost or a decline in yield. According to Patent Document No. 3, to drive the reflecting and transmitting regions independently of each other, each of the reflecting and transmitting regions has a structure that is equivalent to that of a single pixel. That is why a TFT LCD with such a complicated structure should have twice as many TFTs and source lines, to say the least, as an LCD with the multi-gap structure. On top of that, since the reflecting and transmitting regions, each of which is associated with a pixel, are not electrically equivalent to each other, the structure of such an LCD is more complicated than that of a TFT LCD, of which the number of pixels is simply doubled.

Patent Document No. 4 discloses an LCD that can avoid increasing the number of TFTs to provide and the complexity of a drive voltage control by splitting the electrostatic capacitance in the reflecting region and by making a difference in drive voltage between the transmitting and reflecting regions. One of the methods for splitting the electrostatic capacitance in the reflecting region as disclosed in Patent Document No. 4 is to deposit an insulating film on a reflective electrode so that the capacitor defined by a part of the liquid crystal layer sandwiched between the reflective electrode and a counter electrode is split into a capacitor defined by the insulating film and a capacitor defined by the liquid crystal layer. According to Patent Document No. 4, an insulating film may also be arranged on a region of the counter electrode so as to face the reflective electrode.

### Citation List

### Patent Literature

Patent Document No. 1: Japanese Patent Application Laid-Open Publication No. 11-316382

Patent Document No. 2: Japanese Patent Application Laid-Open Publication No. 2005-84593

Patent Document No. 3: Japanese Patent Application Laid-Open Publication No. 2005-55595

Patent Document No. 4: Japanese Patent Application Laid-Open Publication No. 2003-57639 (see Paragraph #0055, in particular)

### SUMMARY OF INVENTION

### Technical Problem

According to the method disclosed in Patent Document No. 4, however, an additional process step should be performed to deposit an insulating film on the reflective electrode, thus increasing the manufacturing cost. In addition, as SiO₂ is used as the insulating film, the number of manufacturing process steps should be increased by more than one to mask a transparent electrode and then deposit the SiO₂ film on it.

It is therefore an object of the present invention to provide a transflective liquid crystal display device that can be fabricated without the multi-gap structure by performing a simpler manufacturing process than any of the conventional ones described above.

### Solution to Problem

A liquid crystal display device according to the present invention includes: first and second substrates; a liquid crystal layer, which is interposed between the first and second substrates; a pixel electrode, which includes a reflective pixel electrode and a transparent pixel electrode and which is arranged on the first substrate to face the liquid crystal layer; a counter electrode, which is arranged on the second substrate to face the liquid crystal layer; an organic insulating layer, which has been deposited on the counter electrode to face the liquid crystal layer; and a columnar spacer, which is arranged between the first and second substrates. A reflecting region, including the reflective pixel electrode, conducts a display operation in reflection mode and a transmitting region, including the transparent pixel electrode, conducts a display operation in transmission mode. The organic insulating layer covers either only the reflecting region selectively or the counter electrode substantially entirely, and is thicker in the reflecting region than in the transmitting region. And the columnar spacer is made of the same organic film as the organic insulating layer.

In one preferred embodiment, in the reflecting region, the columnar spacer forms an integral part of the organic insulating layer.

In another preferred embodiment, substantially the same voltage is supplied to the reflective and transparent pixel electrodes.

In still another preferred embodiment, a part of the liquid crystal layer in the reflecting region is almost as thick as another part of the liquid crystal layer in the transmitting region.

In yet another preferred embodiment, the liquid crystal layer contains a liquid crystal material with negative dielectric anisotropy.

### Advantageous Effects of Invention

In a liquid crystal display device according to the present invention, an organic insulating layer that makes the voltage applied to a part of a liquid crystal layer in a reflecting region lower than the one applied to another part of it in a transmitting region and columnar spacers are formed by patterning the same organic film. Consequently, the liquid crystal display device of the present invention can be fabricated by a simpler process than conventional ones.

### BRIEF DESCRIPTION OF DRAWINGS

FIGS. 1(a) and 1(b) are respectively a schematic plan view of a liquid crystal display device 100 as a preferred embodiment of the present invention and a schematic cross-sectional view thereof as viewed on the plane B-B′ shown in FIG. 1(a).

FIG. 2 represents the voltage-transmittance characteristic and voltage-reflectance characteristic of the liquid crystal display device 100 according to the preferred embodiment of the present invention by curves L1 and L2, respectively.

FIG. 3 is a schematic cross-sectional view of a comparative liquid crystal display device 200.

FIG. 4 is a schematic cross-sectional view of another comparative liquid crystal display device 300.

### DESCRIPTION OF EMBODIMENTS

Hereinafter, it will be described with reference to the accompanying drawings what configuration a liquid crystal display device as a specific preferred embodiment of the present invention has and how it operates.

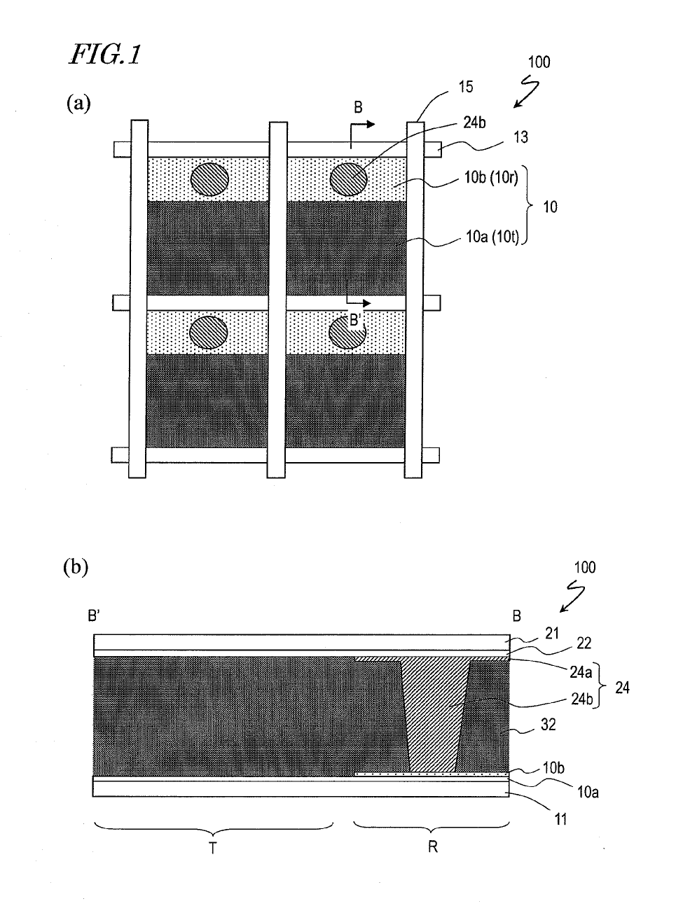

The configuration and operation of a liquid crystal display device 100 as a preferred embodiment of the present invention will now be described with reference to FIG. 1. Specifically, FIGS. 1(a) and 1(b) are respectively a schematic plan view of the liquid crystal display device 100 and a schematic cross-sectional view thereof as viewed on the plane B-B′ shown in FIG. 1(a).

The liquid crystal display device 100 is a transflective LCD in which each pixel has a reflecting region R to conduct a display operation in reflection mode and a transmitting region T to conduct a display operation in transmission mode.

The liquid crystal display device 100 includes two substrates 11 and 21 and a liquid crystal layer 32 that is interposed between the substrates 11 and 21. An alignment layer (not shown) is arranged on the surface of each of the two substrates 11 and 21 to face the liquid crystal layer 32. A pixel electrode 10, consisting of a reflective pixel electrode 10r and a transparent pixel electrode 10t, is arranged on the substrate 11 to face the liquid crystal layer 32. A counter electrode 22 is arranged on the substrate 21 to face the liquid crystal layer 32, too. And an organic insulating layer 24a has been deposited on the counter electrode 22 to face the liquid crystal layer 32 also. A columnar spacer 24b is arranged between the substrates 11 and 21. The pixel electrode 10 is connected to a source bus line 15 by way of a TFT (not shown) that is connected to a gate bus line 13.

The pixel electrode 10 includes a transparent conductive layer 10a and a reflective conductive layer 10b. The transparent conductive layer 10a may be made of ITO (indium tin oxide) or IZO (indium zinc oxide), for example. On the other hand, the reflective conductive layer 10b may be a layer of a reflective metal such as aluminum, molybdenum or tungsten or a stack of such metallic materials. The transparent conductive layer 10a and the reflective conductive layer 10b that has been deposited on the layer 10a form the reflective pixel electrode 10r. Alternatively, the transparent conductive layer 10a may be deposited on the reflective conductive layer 10b as well. The rest of the transparent conductive layer 10a without the reflective conductive layer 10b functions as the transparent pixel electrode 10t. The reflective pixel electrode 10r defines the reflecting region R and the transparent pixel electrode 10t defines the transmitting region T. However, the pixel electrode 10 does not always have this particular configuration but may have any of various other known configurations for transflective LCD pixel electrodes. For example, there is no need to directly electrically connect the transparent and reflective pixel electrodes together.

The liquid crystal layer 32 may be a vertical alignment liquid crystal layer that contains a liquid crystal material with negative dielectric anisotropy. The liquid crystal display device 100 is designed to conduct a display operation in normally black mode. Although not shown in FIG. 1, two polarizers are arranged as crossed Nicols on the respective outer surfaces of the substrates 11 and 21. If necessary, an additional phase plate could be further inserted between each substrate 11 or 21 and its associated polarizer.

The organic insulating layer 24a is selectively provided only for the reflecting region R. And the columnar spacer 24b and the organic insulating layer 24a may be formed by patterning the same organic film 24. Although the organic insulating layer 24a is selectively provided only for the reflecting region R in this preferred embodiment, the organic insulating layer 24a could also cover substantially the entire surface of the counter electrode 22 and could be thicker in the reflecting region R than in the transmitting region T. In any case, with such an organic insulating layer 24a provided, even if substantially the same voltage is supplied to the reflective and transparent pixel electrodes 10r and 10t, the voltage applied to a part of the liquid crystal layer 32 in the reflecting region R can still be lower than the one applied to another part of the liquid crystal layer 32 in the transmitting region 32.

In the arrangement illustrated in FIG. 1, the columnar spacer 24b forms an integral part of the organic insulating layer 24a in the reflecting region R. However, the present invention is in no way limited to that specific preferred embodiment. If necessary, columnar spacers 24b may also be arranged elsewhere, not just in the reflecting region R. Nevertheless, the columnar spacers 24b should be arranged outside of the transmitting region T and are preferably arranged to overlap with a black matrix (not shown). This is because in the vicinity of those columnar spacers 24b, alignment of liquid crystal molecules could be disturbed so much as to have unbeneficial influence on display operation. In FIG. 1(a), only one columnar spacer 24b is provided for each pixel. However, it is not always necessary to adopt such an arrangement. Instead, one columnar spacer 24b could be provided for multiple pixels as well.

FIG. 2 represents the voltage-transmittance characteristic and voltage-reflectance characteristic of the liquid crystal display device 100 by curves L1 and L2, respectively. In FIG. 2, the abscissa represents the voltages applied to the reflective and transparent pixel electrodes 10r and 10t, while the ordinate represents the reflectance in the reflecting region R and the transmittance in the transmitting region T. Also indicated by the curve L3 in FIG. 2 is the voltage-reflectance characteristic in the reflecting region of a comparative liquid crystal display device with no organic insulating layer 24a provided for the reflecting region R.

As shown in FIG. 2, if the same voltage were applied to respective parts of the liquid crystal layer in the transmitting and reflecting regions T and R without varying its thickness between them, then the voltage-reflectance characteristic in the reflecting region as represented by the curve L3 would start to rise at a lower voltage than the voltage-transmittance characteristic in the transmitting region as represented by the curve L1. In addition, the curve L3 would reach a local maximum at a lower voltage than the curve L1, and the reflectance would decrease eventually. This is because the light for use to conduct a display operation in the reflecting region R passes the liquid crystal layer 32 twice. That is to say, while passing the liquid crystal layer 32 twice, the light for use to get a display operation done in the reflection mode will cause twice as great a phase difference as the light that passes the liquid crystal layer 32 in transmitting region T once. As a result, the voltage-reflectance curve L3 will shift toward a lower voltage range compared to the voltage-transmittance curve L1.

On the other hand, the liquid crystal display device 100 makes the organic insulating layer 24a selectively cover only the reflecting region R. That is why even if substantially the same voltage is supplied to the reflective pixel electrode 10r and the transparent pixel electrode 10t, the voltage applied to a part of the liquid crystal layer 32 in the reflecting region R can still be lower than the one applied to another part of the liquid crystal layer 32 in the transmitting region T. Consequently, the voltage-reflectance curve L2 for the reflecting region R of the liquid crystal display device 100 will shift toward a higher voltage range compared to the voltage-reflectance curve L3 of the comparative example and will be rather close to the voltage-transmittance curve L1. That is to say, if the transmittance and reflectance indicated by the curves L1 and L2 are represented by relative values, those curves will be substantially combined into a single curve. In other words, the thickness of the organic insulating layer 24a may be adjusted so that such a curve representing the voltage-transmittance characteristic in the transmitting region T and the voltage-reflectance characteristic in the reflecting region R by relative values can be reduced into a single curve (i.e., a voltage-relative luminance curve).

The voltage applied to a part of the liquid crystal layer 32 in the reflecting region R is obtained by subtracting the magnitude of the voltage drop caused by the organic insulating layer 24a from the voltage applied between the reflective pixel electrode 10R and the counter electrode 22 (i.e., the voltage applied to another part of the liquid crystal layer 32 in the transmitting region T). The voltage drop caused by the organic insulating layer 24a is determined by the respective relative dielectric constants, volume specific resistivities and thicknesses of the liquid crystal layer 32 and the organic insulating layer 24a. Strictly speaking, the relative dielectric constants, volume specific resistivities and thicknesses of the alignment layers that are deposited on the pixel electrode 10 and the counter electrode 32 to face the liquid crystal layer 32 naturally have some impact on the voltage drop, too. If currently used vertical alignment layers and a liquid crystal layer, which is made of a liquid crystal material with negative dielectric anisotropy in the vertical alignment (VA) mode and which has a thickness of 2.8 to 5.0 μm, are combined with an organic insulating layer with a relative dielectric constant of about 3.0 to 4.5 and a volume specific resistivity of about 2×10¹⁵ Ω/cm, then the relation described above can be satisfied by setting the thickness of the organic insulating layer 24a within the range of 0.1 to 0.7 μm. In this manner, by providing such an organic insulating layer 24a, of which the thickness is less than 15% of that of the liquid crystal layer 32, the voltage-luminance characteristics can be substantially matched between the reflecting region R and the transmitting region T. And by selecting an appropriate material for the organic insulating layer 24a, the thickness of the organic insulating layer 24a can be easily reduced to less than 10% of that of the liquid crystal layer 32.

Since the organic insulating layer 24a is formed in the process step of forming the columnar spacers 24b by patterning the same material, there is no need to increase the number of manufacturing process steps at all. That is to say, just by using a conventional photosensitive resin to make the columnar spacers 24b and slightly modifying the photomask, the columnar spacers 24b and the organic insulating layer 24a can be formed at the same time.

For example, if a negative photosensitive resin (i.e., a negative photoresist) is used, the transmittance at a mask opening that exposes a region to be the organic insulating layer 24a may be set to be 10% of the transmittance at another mask opening that exposes a region to be the columnar spacer 24b. Then, an organic insulating layer 24a can be formed so as to have a thickness that accounts for 10% of the thickness of the columnar spacer 24b. Such a photomask can be what is called either a “half-tone mask” or a “gray-tone mask”, for example.

Unlike its counterparts disclosed in Patent Documents Nos. 1 and 2, the liquid crystal display device 100 of the preferred embodiment of the present invention described above has no level difference to optimize the thickness of the liquid crystal layer 32 between the reflecting and transmitting regions R and T and will never cause debased display quality. On top of that, the liquid crystal display device 100 of this preferred embodiment does not need any complicated arrangement such as the one adopted in Patent Document No. 3 to drive the reflecting and transmitting regions independently of each other.

In addition, this liquid crystal display device 100 has the following advantages, too.

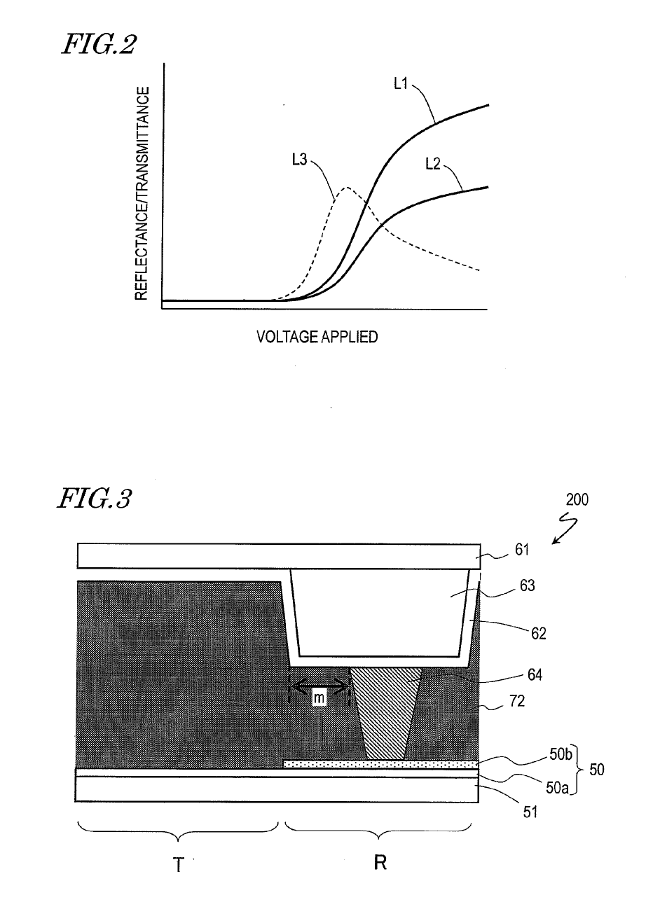

FIG. 3 is a schematic cross-sectional view of a comparative liquid crystal display device 200. As shown in FIG. 3, in the liquid crystal display device 200, a pixel electrode 50 consisting of a reflective pixel electrode and a transparent pixel electrode is also formed by using a transparent conductive layer 50a and a reflective conductive layer 50b that have been deposited in this order on a substrate 51. A transparent resin layer 63 has been deposited on a region of the other substrate 61 to face the reflective conductive layer 50b. And the thickness of a part of the liquid crystal layer 72 in the reflecting region has been adjusted to approximately a half of the thickness of another part of the liquid crystal layer 72 in the transmitting region. A counter voltage 62 is arranged on the transparent resin layer 63 to face the liquid crystal layer 72. And the same voltage is applied to respective parts of the liquid crystal layer 72 in the reflecting and transmitting regions R and T.

In such a liquid crystal display device, if a columnar spacer 64 is provided for the reflecting region R, a sufficient positioning margin (as indicated by the double-headed arrow in FIG. 3) should be left between the transparent resin layer 63 and the columnar spacer 64 in order to minimize a variation in the height of the columnar spacers 64. That is why the size of the reflecting region R cannot be set arbitrarily, and therefore, a sufficient space cannot be left for the transmitting region T, either.

On the other hand, in the liquid crystal display device 100, there is no need to provide any transparent resin layer for the reflecting region R, and therefore, a sufficiently large transmitting region T can be left without causing such a problem. On top of that, by adopting the arrangement in which the columnar spacers 24b form integral parts of the organic insulating layer 24a, the variation in the height of the columnar spacers 24b can be reduced significantly, too.

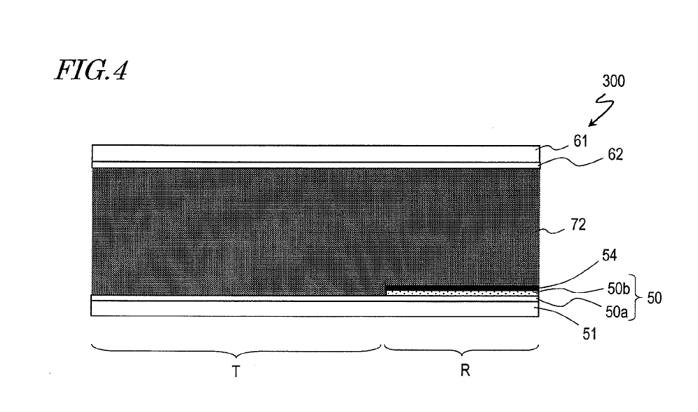

FIG. 4 is a schematic cross-sectional view of another comparative liquid crystal display device 300. As disclosed in Patent Document No. 4 mentioned above, the liquid crystal display device 300 has an insulating layer 54 that selectively covers only the reflective pixel electrode (i.e., a portion with the reflective conductive layer 50b) in the pixel electrode 50. The insulating layer 54 may be an SiO₂ film deposited by CVD process, for example. To leave the SiO₂ film only over the reflective pixel electrode, a mask is defined so as to selectively cover a region to be a transparent pixel electrode (i.e., a part of the transparent conductive layer 50a that is not covered with the reflective conductive layer 50b), an SiO₂ film is deposited on that mask, and then the mask is removed. However, if the insulating layer 54 were made of an inorganic material such as SiO₂, the manufacturing process would get too much complicated to avoid increasing the manufacturing cost. On top of that, it is virtually impossible to form a spacer out of an inorganic insulating layer. And even if an arrangement in which the insulating layer 54 is arranged on the counter electrode 62 to face the liquid crystal layer 72 is adopted, the manufacturing process cannot but be overly complicated anyway.

As described above, in the liquid crystal display device 100 of the preferred embodiment of the present invention described above, the organic insulating layer 24a, which will make the voltage applied to a part of the liquid crystal layer in the reflecting region lower than the one applied to another part of the liquid crystal layer in the transmitting region, and the columnar spacers 24b are formed by patterning the same organic film 24. Consequently, this liquid crystal display device 100 can be fabricated by performing a simpler manufacturing process than the conventional liquid crystal display device disclosed in Patent Document No. 4.

### INDUSTRIAL APPLICABILITY

The present invention can be used effectively to provide a transflective liquid crystal display device for mobile electronic devices, among other things.

### REFERENCE SIGNS LIST

11, 21 substrate

13 gate bus line

15 source bus line

10, 50 pixel electrode

10r reflective pixel electrode

10t transparent pixel electrode

22, 62 counter electrode

24 organic insulating layer

24a organic insulating layer

24b columnar spacer

32, 72 liquid crystal layer

100, 200, 300 liquid crystal display device

1. A liquid crystal display device comprising:
first and second substrates;
a liquid crystal layer, which is interposed between the first and second substrates;
a pixel electrode, which includes a reflective pixel electrode and a transparent pixel electrode and which is arranged on the first substrate to face the liquid crystal layer;
a counter electrode, which is arranged on the second substrate to face the liquid crystal layer;
an organic insulating layer, which has been deposited on the counter electrode to face the liquid crystal layer; and
a columnar spacer, which is arranged between the first and second substrates,
wherein a reflecting region, including the reflective pixel electrode, conducts a display operation in reflection mode and a transmitting region, including the transparent pixel electrode, conducts a display operation in transmission mode, and
wherein the organic insulating layer covers either only the reflecting region selectively or the counter electrode substantially entirely, and is thicker in the reflecting region than in the transmitting region, and
wherein the columnar spacer is made of the same organic film as the organic insulating layer.

2. The liquid crystal display device of claim 1, wherein in the reflecting region, the columnar spacer forms an integral part of the organic insulating layer.

3. The liquid crystal display device of claim 1, wherein substantially the same voltage is supplied to the reflective and transparent pixel electrodes.

4. The liquid crystal display device of claim 1, wherein a part of the liquid crystal layer in the reflecting region is almost as thick as another part of the liquid crystal layer in the transmitting region.

5. The liquid crystal display device of claim 1, wherein the liquid crystal layer contains a liquid crystal material with negative dielectric anisotropy.
